(19) United States
(12) Patent Application Publication
(10) Pub. No.: US 2010/0128066 A1
(43) Pub. Date: May 27, 2010

(54) IMAGE DISPLAY METHOD AND APPARATUS

(75) Inventors: Noboru Murata, Ise-shi (JP); Toru Kohama, Ise-shi (JP); Masaaki Nakamura, Ise-shi (JP)

Correspondence Address: OLIFF & BERRIDGE, PLC, P.O. BOX 320850, ALEXANDRIA, VA, 22320-4850, US

(73) Assignees: NORITAKE CO., LIMITED, NAGOYA-SHI (JP); NORITAKE ITRON CORPORATION, ISE-SH (JP)

(21) Appl. No.: 12/451,182

(22) PCT Filed: May 1, 2008
(86) PCT No.: PCT/JP2008/058339

§ 371 Date: Nov. 25, 2009

(30) Foreign Application Priority Data
May 1, 2007 (JP) 2007-121320
Jan. 30, 2008 (JP) 2008-019757

(51) Int. Cl. G09G 5/10

(52) U.S. Cl. 345/690

(57) ABSTRACT

It is provided at a reasonable cost an image display method and image display apparatus having a small-sized display drive control circuits even in the case of many intensity levels.

The plurality of bit strings constituting the indicative data D defining multiple intensity levels are divided into the first bit group including a plurality of bits and the second bit group including a plurality of bits except the bits included in the first bit group, and they are alternately supplied to the input terminals, predetermined light-emitting bodies 22 is lighted in an intensity level corresponding to the first bit group, in the first period K1 set in a luminous control period that is repeatedly assigned to the predetermined light-emitting bodies, and the predetermined light-emitting element 22 is lighted in a relatively finely-set intensity level corresponding to the second bit group, in the second period K2 set in a luminous control period. Even in the case of many intensity levels, a small-sized display drive control circuits 30 can be provided in a reasonable cost.

### TECHNICAL FIELD

The present invention relates to an image display method and image display apparatus configured to display in an intensity level for a display device in which a control electrode such as a fluorescence display tube, PDP or LCD and light-emitting point electrode group constitutes an X-Y matrix.

### BACKGROUND ART

There is known a pulse width modulating intensity level displaying method having a plurality of light-emitting bodies disposed on a surface to constitute a plurality of pixels, and a display drive control circuit including a plurality of input terminals corresponding to the number of bits of the indicative data supplied to light the light-emitting bodies, and a plurality of parallel signal processing circuits corresponding to the input terminals, the display drive control circuit configured to drive the light-emitting bodies in a pulse width corresponding to the intensity level defined by the indicative data, and the method displaying the image having the intensity level defined by the indicative data on a fluorescence display tube. For instance, this technique is disclosed in Patent Literature 1.

### Patent Literature 1: JP 2003-131621

According to the aforementioned pulse width modulating intensity level displaying method, it is characterized that the control circuit is lightened of load by large reduction in times of data transfer per one indicative cycle by the weighted period.

### SUMMARY OF INVENTION

### Technical Problem

The circuit for the aforementioned conventional pulse width modulating intensity level displaying method is provided with input terminals corresponding to the number of bits constituting the indicative data in order to input the indicative data defining the intensity level, and a indicative drive control circuit including a plurality of parallel signal processing circuit connected to them. However, it is a disadvantage for the conventional indicative drive control circuit that the size of the circuit and the cost should increase with accordance with an increase in the intensity level defined by the indicative data and the number of bits, due to a proportional increase in the number of the aforementioned input terminals and a plurality of the parallel signal processing circuit connected to them. For instance, since the indicative data for 8 intensity levels is constituted of 3 bits, three pairs of the input terminals and the parallel signal processing circuits connected to them are sufficient. In the case of the indicative data for 64 intensity levels, it is constituted of 6 bits. Then, six pairs of the input terminals and the parallel signal processing circuits connected to them are required, and, accordingly, the display drive control circuits are required on a twofold scale.

Further, when integrated display drive control circuits are manufactured, it is difficult to provide various kinds of them, and various kinds of integrated display drive control circuits are required to be manufactured in accordance with the respective intensity levels, accordingly, it is a disadvantage that it causes high costs.

Then, although not yet disclosed, it is inventable without increasing the scale of the display drive control circuit and high costs, that displaying in, for instance, the aforementioned 64 intensity levels are achieved by dividing a plurality of bits, that is, 6 bits constituting the indicative data defining multiple intensity levels, that is, 64 intensity levels, into the upper digit bit group including upper 3 bits and the lower digit bit group including lower 3 bits and alternately inputting them to the aforementioned input terminals, by displaying in a relatively roughly-set intensity level corresponding to the upper digit bit group in the first period, and in a relatively finely-set intensity level corresponding to the lower digit bit group in the second period. However, in this case, the second period is shorter, that is, eighth (⅛) of the indicative cycle than the first period, and, accordingly, it is insufficient of time to send the indicative data of the lower 3 bits in the second period, then, the input of the indicative data of the lower 3 bits with adding an additional period following the second period is required to receive the indicative data, however, it causes a disadvantage that the additional period is useless because it does not contribute to emitting light and reduces luminance of the image display apparatus. Otherwise, it is inventable that a high frequency clock is provided to supply the indicative data for displaying the aforementioned second period to the second period, however, it is expensive and raises the cost.

It is therefore an object of the present invention to provide an improvement of the image display method and image display apparatus to implement the method having the small-sized display drive control circuit at a reasonable cost in more intensity levels. And it is another object of the present invention to provide an improvement of the image display method and image display apparatus to implement the method having the small-sized display drive control circuit at a reasonable cost in more intensity levels without reduction of luminance in the image display apparatus.

### Solution to Problem

The object defined above may be achieved according to the invention in claim 1, which provides an image display method for displaying an image having an intensity level defined by indicative data, (a) including a plurality of light-emitting bodies disposed on a surface to constitute a plurality of respective pixels, a parallel signal processing circuit corresponding to a plurality of input terminals and output terminals to which the indicative data supplied to light the plurality of light-emitting bodies are input, including: (b) a display data supply step for dividing a plurality of bits constituting the indicative data that define the number of the intensity level more than the number of the intensity level defined by the number of a bit corresponding to the number of the input terminal, into a first bit group and a second bit group, and for alternately supplying them to the input terminals; (c) a first period luminous control step for lighting predetermined light-emitting bodies selected from the plurality of light-emitting bodies in an intensity level corresponding to the first bit group of the indicative data, in a first period set in a luminous control period that is repeatedly assigned to the predetermined light-emitting bodies; and (d) a second period luminous control step for lighting the predetermined light-emitting bodies in an intensity level corresponding to the second bit group of the indicative data, in a second period set following the first period in the luminous control period.

The object defined above may be achieved according to another invention in claim 5, which provides an image display apparatus for displaying an image having an intensity level defined by indicative data, (a) including a plurality of light-emitting bodies disposed on a surface to constitute a plurality of respective pixels, a parallel signal processing circuit corresponding to a plurality of input terminals and output terminals to which the indicative data supplied to light the plurality of light-emitting bodies are input, including: (b) a display data supply means for dividing a plurality of bits constituting the indicative data that define the number of the intensity level more than the number of the intensity level defined by the number of a bit corresponding to the number of the input terminal, into a first bit group and a second bit group, and for alternately supplying them to the input terminals; (c) a first period luminous control means for lighting predetermined light-emitting bodies selected from the plurality of light-emitting bodies in an intensity level corresponding to the first bit group by supplying the indicative data of the first bit group to the input terminals, in a first period set in a luminous control period that is repeatedly assigned to the predetermined light-emitting bodies; and (d) a second period luminous control means for lighting the predetermined light-emitting bodies in an intensity level corresponding to the second bit group by supplying the indicative data of the second bit group to the input terminals, in a second period set following the first period in the luminous control period.

### ADVANTAGEOUS EFFECTS OF INVENTION

According to the inventions in claims 1 and 5, a display data supply step or means divides a plurality of bits constituting the indicative data constituted of the number of bits more than the number of a bit corresponding to the number of the input terminal in order to define the number of the intensity level more than the number of the intensity level defined by the number of bits corresponding to the number of the input terminal, into a first bit group and a second bit group, and for alternately supplies them to the input terminals; a first period luminous control step or means lights predetermined light-emitting bodies selected from the plurality of light-emitting bodies in an intensity level corresponding to the first bit group of the indicative data, in a first period set in a luminous control period that is repeatedly assigned to the predetermined light-emitting bodies; and a second period luminous control step or means lights the predetermined light-emitting bodies in an intensity level corresponding to the second bit group of the indicative data, in a second period set prior to or following the first period in the luminous control period. Accordingly, since the display drive control circuit including the fewer input terminals than the value of bits defining the intensity level of the aforementioned indicative data and the following parallel signal processing circuits connected is sufficient, even if the value of the intensity level increases, a small-sized display drive control circuits can be provided at a reasonable cost.

Preferably, the display data supply step or means divides the plurality of bit strings constituting the indicative data into the first bit group including a plurality of bits which constitute each of the bit strings and are positioned in non-successive order in the bit string and the second bit group including a plurality of bits except the bits included in the first bit group, and alternately supplies them to the input terminals. That is, the first bit group to control the intensity levels in the first period includes a plurality of bits which constitute each of the bit strings and are positioned in non-successive order in the bit string selected from a plurality of bit strings constituting the indicative data, and the second bit group including a plurality of bits except the bits included in the first bit group selected from a plurality of bits constituting the indicative data. Accordingly, since the second period has a longer duration of time, in comparison with another case in which the second bit group is constituted of the lower bits selected from a plurality of bits constituting the indicative data, and the duration of time of the second period approaches that of the first period, it is not necessary to reduce the luminance of the image display apparatus or to use a high frequency clock for providing the indicative data in order to define the second period, and, consequently, a small-sized display drive control circuits can be provided at a reasonable cost.

Preferably, the first bit group includes an uppermost bit and a lowermost bit of each of the indicative data, and the second bit group includes a plurality of intermediate bits interposed by the bits constituting the first bit group. Accordingly, since the second period has a longer duration of time, in comparison with another case in which the second bit group is constituted of the lower bits selected from a plurality of bits constituting the indicative data, and the duration of time of the second period approaches that of the first period, it is not necessary to reduce the luminance of the image display apparatus or to use a high frequency clock for providing the indicative data in order to define the second period, and, consequently, a small-sized display drive control circuits can be provided at a reasonable cost.

Preferably, the display data supply step divides the plurality of bit strings constituting the indicative data into the first bit group including upper part of the bit strings, that is, a predetermined number of successive bits including the most significant bit (MSB) in the bit strings and the second bit group including lower part of the bit strings, that is, a predetermined number of successive bits including the least significant bit (LSB) in the bit strings, and alternately supplies them to the input terminals. Accordingly, since the display drive control circuit including the fewer input terminals than the value of bits defining the intensity level of the aforementioned indicative data and the following parallel signal processing circuits connected is sufficient, even if the value of the intensity level increases, a small-sized display drive control circuits can be provided at a reasonable cost.

Preferably, (a) the first period luminous control means outputs a first GCP signal defining timing to steppingly reduce along with time elapsing in the first period; (b) the second period luminous control means outputs a second GCP signal defining timing to steppingly reduce along with time elapsing in the second period; and (c) the display drive control circuit includes a luminous pulse width control circuit configured to compare the first GCP signal and the first bit group in the first period, and to output a comparison signal when a value defined by the first GCP signal is equal to or lower than a value defined by the first bit group, and to compare the second GCP signal and the second bit group in the second period, and to output a comparison signal when a value defined by the second GCP signal is equal to or lower than a value defined by the second bit group, and a drive circuit configured to light the light-emitting element in response to an output of the comparison signal from the luminous pulse width control circuit. Accordingly, during the summed period of the first period from the output of the comparison signal to the termination of the first period and the second period from the output of the comparison signal to the termination of the second period, the light-emitting element is lighted, and displaying the intensity level defining the indicative data is achieved.

Preferably, (a) the first period luminous control means outputs a first GCP signal defining timing to steppingly increase along with time elapsing in the first period; (b) the second period luminous control means outputs a second GCP signal defining timing to steppingly increase along with time elapsing in the second period; and (c) the display drive control circuit includes a luminous pulse width control circuit configured to compare the first GCP signal and the first bit group in the first period, and to output a comparison signal when a value defined by the first GCP signal exceeds a value defined by the first bit group, and to compare the second GCP signal and the second bit group in the second period, and to output a comparison signal when a value defined by the second GCP signal exceeds a value defined by the second bit group, and a drive circuit configured to put out the light-emitting element in response to an output of the comparison signal from the luminous pulse width control circuit. Accordingly, during the summed period of the first period from the initiation of the first period to the output of the comparison signal and the second period from the initiation of the second period to the output of the comparison signal, the light-emitting element is lighted, and displaying the intensity level defining the indicative data is achieved.

Preferably, (a) the plurality of light-emitting bodies disposed are fluorescent bodies that are disposed on a positive electrode of a fluorescence display tube and are configured to light by collision of an electron generated in a cathode of the fluorescence display tube and accelerated through any of a plurality of control grids; and (b) the luminous control period assigned to the predetermined light-emitting bodies is a period in which an accelerated voltage is applied to a control grid covering the predetermined light-emitting bodies selected from the control grids; and (c) the apparatus further includes a grid switching means for serially selecting light-emitting bodies capable of emitting light from the plurality of light-emitting bodies disposed, by serially and repeatedly applying a control voltage pulse to the plurality of control grids. Accordingly, the fluorescent body of the fluorescence display tube is displayed in the intensity level of the indicative data by fewer display drive control circuits including the input terminals and the parallel signal processing circuits connected to them, than the number of the bits defining the intensity level of the indicative data.

Preferably, the grid switching means serially and repeatedly applies one control voltage pulse having a time width corresponding to the first period and the following second period, to the plurality of control grids. Accordingly, the fluorescent body of the fluorescence display tube is displayed in the intensity level of the indicative data by fewer display drive control circuits including the input terminals and the parallel signal processing circuits connected to them, than the number of the bits defining the intensity level of the indicative data.

Preferably, the grid switching means serially applies a first control voltage pulse having a time width corresponding to the first period to the plurality of control grids, and then serially applies a second control voltage pulse having a time width corresponding to the second period to the plurality of control grids, and repeatedly applies them. Accordingly, the fluorescent body of the fluorescence display tube is displayed in the intensity level of the indicative data by fewer display drive control circuits including the input terminals and the parallel signal processing circuits connected to them, than the number of the bits defining the intensity level of the indicative data.

### BRIEF DESCRIPTION OF DRAWINGS

FIG. 1 is the schematic view for explaining a system of an image display apparatus according to an embodiment of the present invention.

FIG. 2 is the schematic view for explaining a system of the fluorescence display tube provided in the image display apparatus according to the embodiment in FIG. 1.

FIG. 3 is the schematic view for explaining a system of the display drive control circuit provided in the image display apparatus according to the embodiment in FIG. 1.

FIG. 4 is the schematic view for explaining an example of the circuit system of the indicative data supply means in FIG. 3.

FIG. 5 is the schematic view for explaining an example of the circuit system of a part of the timing control means and the luminous control means in FIG. 3.

FIG. 6 is the time chart for explaining the function and operation of the display drive control circuit and display control unit provided in the image display apparatus.

FIG. 7 is the flowchart for explaining a major part of control function of the display control unit according to the embodiment in FIG. 1.

FIG. 8 is the schematic view for explaining an example of the circuit system of the indicative data supply means according to another embodiment (Example 2) of the present invention, corresponding to FIG. 4.

FIG. 9 is the schematic view for explaining an example of the circuit system of a part of the timing control means and the luminous control means in FIG. 8.

FIG. 10 is the time chart for explaining the function and operation of the display drive control circuit and display control unit, corresponding to FIG. 6, in which the indicative data is divided into the upper digit bit group constituted of the upper digit bits and the lower digit bit group constituted of the lower digit bits.

FIG. 11 is the time chart for explaining the function and operation of the display drive control circuit and display control unit, in which an additional period to supply the upper digit bit group selected from the indicative data is added in the aforementioned Example 2 without a high frequency clock.

FIG. 12 is the time chart for explaining the function and operation in the image display apparatus according to another embodiment (Example 3) of the present invention, corresponding to FIGS. 6 and 10.

FIG. 13 is the time chart for explaining the function and operation in the image display apparatus according to another embodiment (Example 4) of the present invention, corresponding to FIGS. 6 and 10.

FIG. 14 is the time chart for explaining the function and operation in the image display apparatus according to another embodiment (Example 5) of the present invention, corresponding to FIGS. 6 and 10.

FIG. 15 is the time chart for explaining the function and operation in the image display apparatus according to another embodiment (Example 6) of the present invention, corresponding to FIGS. 6 and 10.

### REFERENCE SIGNS LIST

10: Image display apparatus
12: Fluorescence display tube (Image display device)
22: Light-emitting element (Light-emitting body, Pixel)
30: Display drive control circuit
36: First input terminal,
38: Second input terminal,
40: Third input terminal (Input terminal)
42: First shift register (Parallel signal processing circuit)
44: Second shift register (Parallel signal processing circuit)
46: Third shift register (Parallel signal processing circuit)
48: First latch circuit (Parallel signal processing circuit)
50: Second latch circuit (Parallel signal processing circuit)
52: Third latch circuit (Parallel signal processing circuit)
60: Timing control means
62: Grid switching means
64: Indicative data supply means
68: First period luminous control means
70: Second period luminous control means
D: Indicative data
K1: First period
K2: Second period
TD1: First indicative data supply period
TD2: Second indicative data supply period

### DESCRIPTION OF EMBODIMENTS

Referring to the drawings, there will be described in detail a preferred embodiment of the present invention.

### Example 1

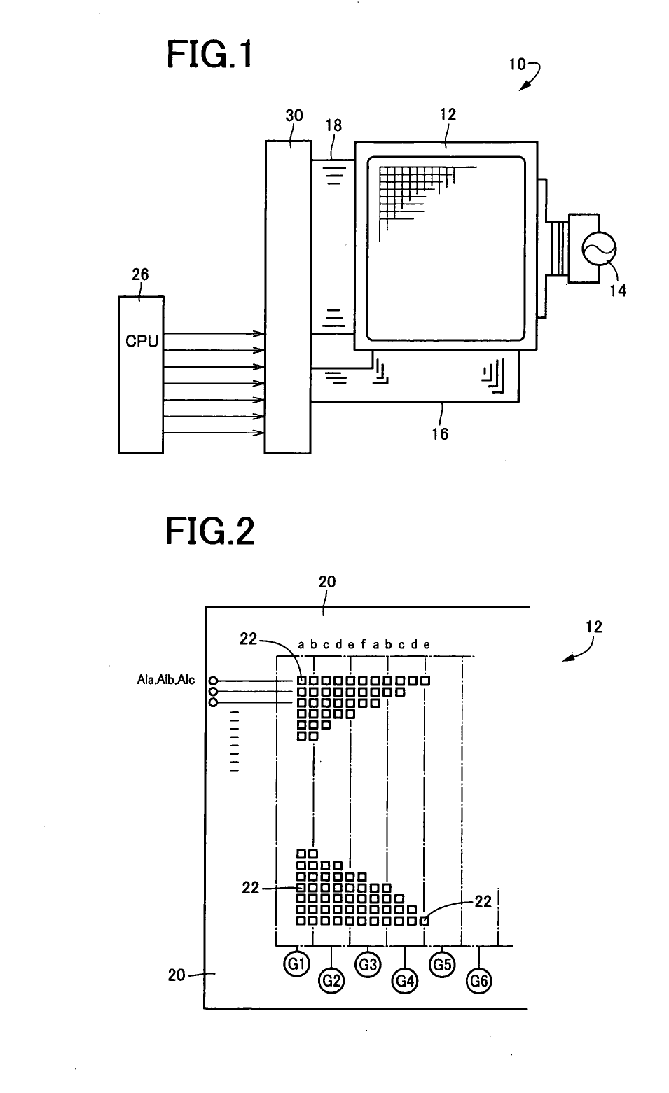

FIG. 1 illustrates an example of an image display apparatus 10 according to an embodiment of the present invention, provided with a typical fluorescence display tube 12 displaying images by a simple matrix drive. Referring to FIG. 1, the fluorescence display tube 12 functions as an image display device and is provided with a cathode (not shown) functioning as an electron source connected to a cathode power source 14 through a transformer, a plurality of grids Gn connected by a plurality of lead wires 16 for grids Gn, and a plurality of anodes connected by a plurality of lead wires 18 for anodes, in a vacuum container (not shown), for instance, formed by a pair of glass plates between which a spacer is interposed. Referring to FIG. 2, on a glass substrate 20 that is one of the pair of glass plates, a plurality of light-emitting elements 22 are disposed in a dot pattern and on a surface of the glass substrate 20, the light-emitting elements being formed of a fluorescent material layer formed on a plurality of anode electrode patterns. On the light-emitting elements 22 a plurality of grids Gn that are longitudinally extending and spaced at a predetermined interval are fixed, and on the plurality of grids Gn the cathode is disposed at a predetermined interval in the perpendicular direction to the direction that the plurality of grids Gn extend. On the glass substrate 20 light-emitting elements selected from the plurality of the light-emitting elements 22 disposed at a predetermined interval in a row are connected to an anode terminal, for instance, the light-emitting elements at lines marked “a” in FIG. 2 are connected to an anode terminal Ala, the light-emitting elements at lines marked “b” in FIG. 2 are connected to an anode terminal A1b, and the light-emitting elements at lines marked “c” in FIG. 2 are connected to an anode terminal A1c, and the anode terminals such as A1a, A1b and A1c are formed in each row of the light-emitting elements 22 in FIG. 2. The light-emitting element 22 that is disposed under the grid Gn to which a control voltage is applied, and to which an acceleration (anode) voltage is applied is to emit light. In the fluorescence display tube 12 functioning as the image display device, one light-emitting element 22 functions as one display pixel.

Referring back to FIG. 1, a display control unit 26 is an electronic control unit constituted of a microcomputer provided with a CPU, RAM, ROM and input/output I/F, processes an input signal according to a program previously stored in the ROM utilizing a temporary storage function of the RAM, and outputs such as a BK (blanking) signal to inhibit displaying in a slight period in switching timing of a display control cycle, a GCP (gray scale control pulse) signal defining a timing pulse that steppingly reduces, for instance, from “35” to “0” along with time elapsing in order to form an emission time (pulse width) corresponding to a plurality of intensity levels defining indicative data D, a LAT (latch) signal, and a grid signal for implementing a grid scan to serially and periodically apply the control (acceleration) voltage in a predetermined frequency and applying time for the plurality of grids Gn. The indicative data D are those defining the intensity level of one pixel in an image memory of one frame, storing an image to be displayed on the fluorescence display tube 12, and they are supplied to each of the light-emitting elements 22 in time sharing.

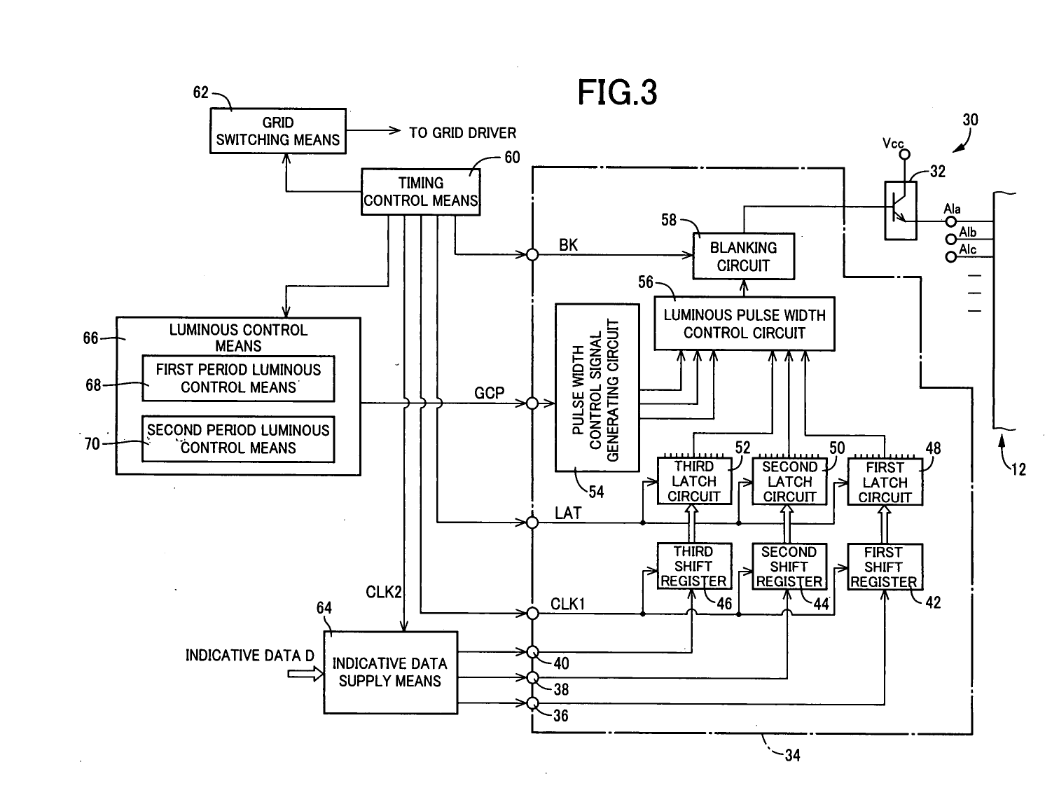

A display drive control circuit 30 is provided for each of the anode terminals such as A1a, A1b and A1c. FIG. 3 illustrates the display drive control circuit 30 connected to the anode terminal A1a. In FIG. 3 the display drive control circuit 30 is provided to permit the light-emitting element 22 to achieve 64 intensity levels of luminance, and is provided with a driver (transistor) 32 connected to the anode terminal A1a to apply the acceleration voltage Vcc to the anode terminal A1a, and an integrated control circuit (driver IC) 34 to drive and control the driver 32.

The control circuit 34 is provided with a first input terminal 36, second input terminal 38, third input terminal 40, first shift register 42, second shift register 44, third shift register 46, first latch circuit 48, second latch circuit 50, third latch circuit 52, pulse width control signal generating circuit (GCP decoder) 54, luminous pulse control circuit 56. Into the first, second and third input terminals 36, 38, 40, a first bit group and second bit group are alternately input in parallel. The first bit group includes an uppermost digit bit b5 and a lowermost digit bit b0 such as a set of b5, b1 and b0 that are selected from the indicative data D, for instance, constituted of six bits b5 to b0 defining luminance in 64 intensity levels, and the second bit group includes a plurality of interposed digit bits, that is, b4, b3 and b2 in this example, interposed among the bits b5, b1 and b0 that constitutes the first bit group. The first, second and third shift registers 42, 44, 46, are configured to serially store each signal supplied into the first, second and third input terminals 36, 38, 40, respectively, in response to a CLK (clock) signal. The first, second and third latch circuits 48, 50, 52 are configured to latch each output signal from the first, second and third shift registers 42, 44, 46 for a predetermined period of time. The pulse width control signal generating circuit (GCP decoder) 54 is configured to convert a GCP signal into a 3-bit parallel signal. The luminous pulse control circuit 56 is configured to compare the 3-bit parallel signal converted from the GCP signal, with three bit signals from the first, second and third latch circuits 48, 50, 52, and to output a comparative output (on-output) through a blanking circuit 58 to the driver 32 when a value of the GCP signal is equal to or lower than a value of the three bit signals. The blanking circuit 58 is configured to interrupt a signal supplied from the luminous pulse width control circuit 56 to the driver 32 in response to a BK (blanking) signal, and to preferentially place the driver 32 in the off state.

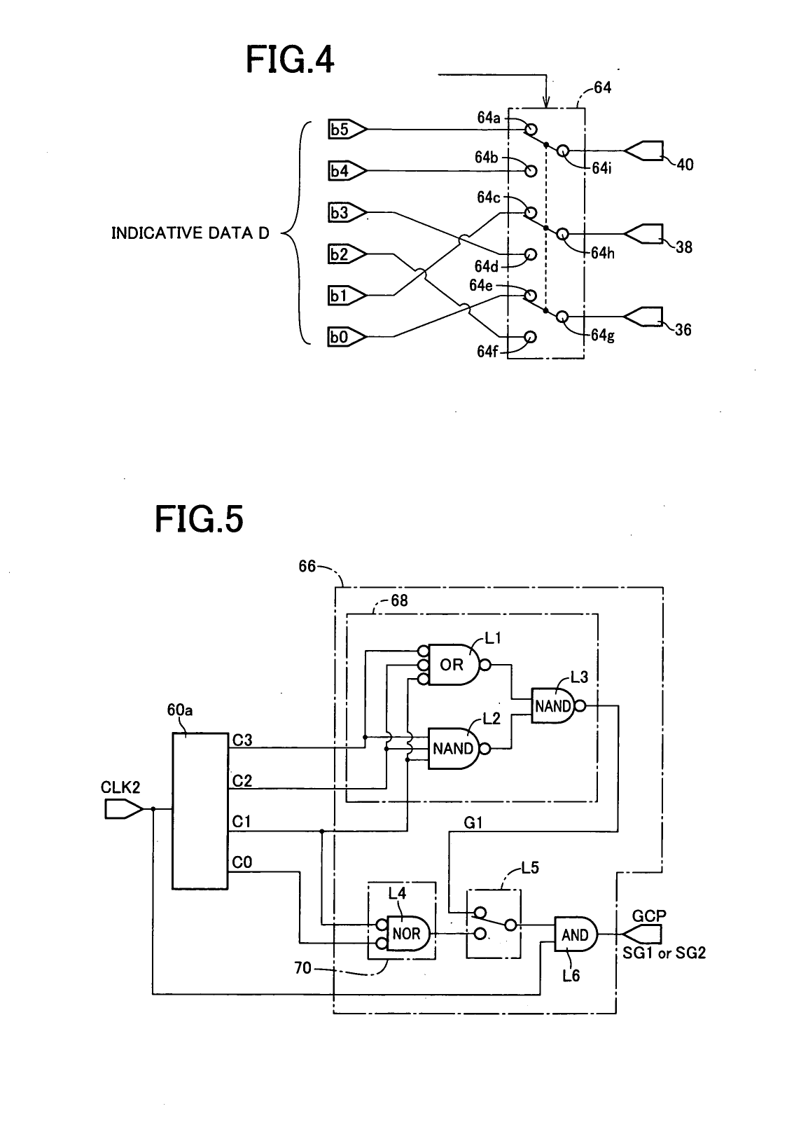

Referring to FIG. 3, a timing control means 60, grid switching means 62, indicative data supply means 64 and luminous control means 66 are functional blocks for explaining a major part of a control function of the aforementioned display control unit 26. FIG. 4 illustrates an example of the indicative data supply means 64. FIG. 5 illustrates an example of a system including a binary counter 60a constituting a part of the timing control means 60, and a first period luminous control means 68 and a second period luminous control means 70 included in the luminous control means 66 in detail.

Referring to FIG. 4, the indicative data supply means 64 is provided with six input terminals 64a, 64b, 64c, 64d, 64e, 64f to which bits b5, b4, b1, b3, b0, b2 included in the 6-bit signal constituting the indicative data D are supplied in parallel, and output terminals 64g, 64h, 64i respectively connected to the first, second and third input terminals 36, 38, 40. The indicative data supply means 64 divides the 6-bit indicative data D into the first bit group of b5, b1 and b0 including the uppermost digit bit b5 and the lowermost digit bit b0 and the second bit group including a plurality of the interposed bits b4, b3 and b2 that are interposed among the bits b5, b1 and b0 constituting the first bit group, by connecting the output terminal 64i to the input terminal 64a or 64b, the output terminal 64h to the input terminal 64c or 64d, and the output terminal 64g to the input terminal 64e or 64f, respectively, by switching, and the means 64 alternately outputs them in parallel.

Referring to FIG. 5, from the binary counter 60a constituting a part of the timing control means 60, binary counter output bits c3, c2, c1, c0 included in a parallel of 4-bit signal are output, upper binary counter output bits c3, c2, c1 of 3-bit are supplied to the first period luminous control means 68. This first period luminous control means 68 is provided with an OR element L1 and first NAND element L2 to which the binary counter output bits c3, c2, c1 are respectively input, and a second NAND element L3 to which the outputs from the OR element L1 and first NAND element L2. And the means 68 outputs the first GCP signal SG1 for the first period K1 to the pulse width control signal generating circuit 54, by the supplied binary counter output bits c3, c2, c1. The first GCP signal SG1 is a pulse defining timing that reduces in seven stages in accordance with any intensity level of “35” to “32” and “3” to “0”. The binary counter output bits c1, c0 that are two lower-side digit bits selected from the aforementioned binary counter output bits c3, c2, c1, c0 are supplied to a switching device L5 through a NOR element L4. The switching device L5 is switched in accordance with a timing signal to a terminal connected to a second NAND element L3 in the first period K1, and to a terminal connected to a NOR element L4 in the second period K2. From the NOR element LA a gating signal to output a second GCP signal SG2 for the second period K2 that is a pulse defining timing for reduction of intensity levels from “28” to “0” at an equal interval by four levels, and the NOR element LA corresponds to a second period luminous control means 70. Thus, each of the first and second GCP signals SG1, SG2 is supplied to the pulse width control signal generating circuit 54, through an AND element L6 in which a gate for a CLK signal CLK2 is opened by the output gating signal to output the signal SG1 in the first period K1 or the output gating signal to output the signal SG2 in the second period K2 from the switching device L5.

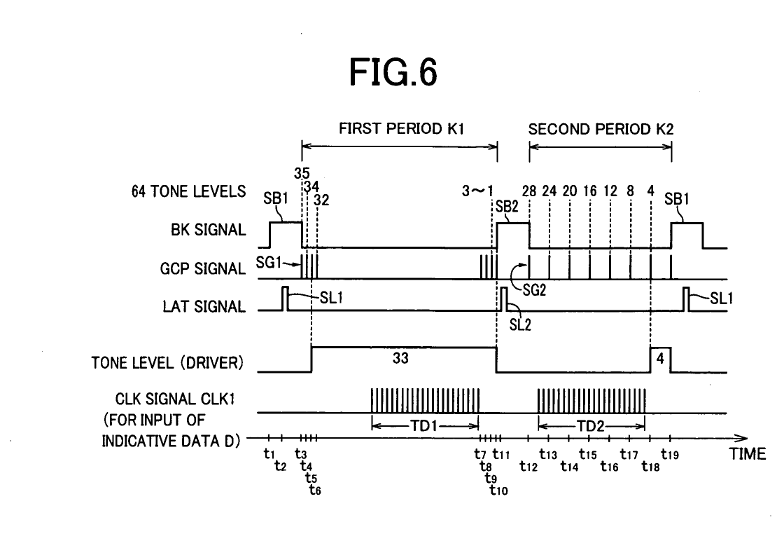

Referring to the time chart of FIG. 6 for explaining the functional blocks, this time chart shows timing and luminous control operation of the aforementioned signals in a luminous control period in which a control voltage is applied to one unit (one or adjacent two grids) of the grid to permit the three-columned light-emitting elements 22 to emit light, in one display cycle in which the grid voltage is serially applied to all the plurality of grids Gn. In one luminous control period, the first period K1 and second period K2 are disposed adjacent to each other interposing the BK signal pulse. In the first period K1 (from point t₃ to t₁₀) a first scanning to form a driver pulse width to form the intensity level defined by the first bit group of the bits b5, b1, b0 including the uppermost digit bit b5 and the lowermost digit bit b0 in the indicative data D is implemented. In the second period K2 (from point t₁₂ to t₁₉) a second scanning to form a driver pulse width to form the intensity level defined by the second bit group including the plurality of interposed bits b4, b3, b2 that are interposed among the bits b5, b1, b0 constituting the first bit group is implemented.

As shown in the time chart of FIG. 6, the timing control means 60 outputs the BK signal, LAT signal and CLK signal CLK1 to the control circuit 34 in each of the luminous control period, and, concurrently, supplies timing signals to control such as initiation of an operation of the grid switching means 62, indicative data supply means 64 and luminous control means 66.

In a predetermined period of luminous control of the light-emitting element 22 implemented in a respective grid switching, the timing control means 60 generates a first BK signal SB1 having a predetermined pulse width at a point t₁ prior to the first period K1 (from t₃ to t₁₀), and generates a second BK signal SB2 having a pulse width equal to that of the first BK signal SB1 at the termination point, that is, a point t₁₀ prior to the second period K2 (from t₁₂ to t₁₉)

In the aforementioned first period K1 in a prior luminous control period, the indicative data supply means 64 divides 6-bit luminous data D defining 64 intensity level luminance of a predetermined light-emitting element 22 in a present luminous control period, into the first bit group of the bits b5, b1, b0 including the uppermost digit bit b5 and the lowermost digit bit b0 and the second bit group including the plurality of interposed bits b4, b3, b2 interposed by the bits b5, b1, b0 constituting the first bit group, and at first supplies the signals of the second bit group of the bits b4, b3, b2 to the first, second and third input terminals 36, 38, 40, respectively. The supplied signals of the second bit group of the bits b4, b3, b2 are stored in the first, second and third shift registers 42, 44, 46, in synchronization with supplying the CLK signal CLK1 in the first indicative data supply period TD1. Then, in the aforementioned second period K2 in the prior luminous control period, the indicative data supply means 64 supplies the remaining signals of the first bit group of the bits b5, b1, b0 to the first, second and third input terminals 36, 38, 40, respectively. The supplied signals of the first bit group of the bits b5, b1, b0 are stored following the signals of the second bit group of the bits b4, b3, b2 in the first, second and third shift registers 42, 44, 46, in synchronization with supplying the CLK signal CLK1 in the second indicative data supply period TD2. In the present luminous control period, the indicative data supply means 64 divides the luminous data D for lighting in the following luminous control period as well, serially supplies the second bit group of the bits b4, b3, b2 in the first period K1 and the first bit group of the bits b5, b1, b0 in the second period K2 to the first, second and third input terminals 36, 38, 40, respectively, and has them serially stored in the first, second and third shift registers 42, 44, 46.

The timing control means 60 generates the first LAT signal SL1 (at point t₂) during generation of the aforementioned first BK signal SB1, and generates the second LAT signal SL2 (at point t₁₁) during generation of the aforementioned second BK signal SB2. By generation of the first LAT signal SL1, the bits b5, b1, b0 of the first bit group of the luminous data D stored in the first, second and third shift registers 42, 44, 46 are latched in the first, second and third latch circuit 48, 50, 52, the bits b5, b1, b0 of the first bit group of the luminous data D latched in the first, second and third latch circuit 48, 50, 52 are supplied to the luminous pulse width control circuit 56 until supply of the second LAT signal SL2. By generation of the second LAT signal SL2, the bits b4, b3, b2 of the second bit group of the luminous data D stored in the first, second and third shift registers 42, 44, 46 are latched in the first, second and third latch circuit 48, 50, 52, the bits b4, b3, b2 of the second bit group of the luminous data D latched in the first, second and third latch circuit 48, 50, 52 are supplied to the luminous pulse width control circuit 56 until supply of the next first LAT signal SL1.

When the timing control means 60 has the first BK signal SB1 fallen (at point t₃), the grid switching means 62 supplies a signal to apply a control voltage to a grid G to light a predetermined light-emitting element 22 until the following luminous control period starts, to the grid driver. Concurrently, the first period luminous control means 68 of the luminous control means 66 starts to supply the first GCP signal SG1 to the pulse width control signal generating circuit 54, and then, the first GCP signal SG1 is converted into a 3-bit parallel signal and the converted signal is supplied from the pulse width control signal generating circuit 54 to the luminous pulse width control circuit 56. The first GCP signal SG1 for the first period K1 that is a pulse defining timing of intensity level reduction such that the intensity levels “35”, “34”, “33”, “32”, “3”, “2”, “1” and “0” correspond to reduction stage numbers “7”, “6”, “5”, “4”, “3”, “2”, “1” and “0” in the first period K1, is output. In an example shown in FIG. 6, the intensity level defined by the luminous data D is “37”, the signals of the bits b5, b1, b0 of the first bit group are “1, 0, 1” and the signals of the bits b4, b3, b2 of the second bit group are “0, 0, 1”, and at t₅ the first GCP signal SG1 and the bits b5, b1, b0 of the first bit group of the luminous data D are compared in the luminous pulse width control circuit 56, then, a value defined by the bits b5, b1, b0 of the first bit group is “5”, which does not exceed a reduction stage number “5” of the first GCP signal SG1, that is, since the reduction stage number “5” of the first GCP signal SG1 is not larger than the value “5” defined by the bits b5, b1, b0 of the first bit group, a comparison signal is output, and the driver 32 is placed in an on state until the second BK signal SB2 is raised, in synchronization with the comparison signal. This period in which the driver 32 is on corresponds to an intensity level “33” in 64 levels in total.

When the timing control means 60 raises the second BK signal SB2 (at point t₁₀) and generates the second LAT signal during raising of the second BK signal SB2 (at point t₁₁), the generation of the second LAT signal causes the signals of the bits b4, b3, b2 of the second bit group of the luminous data D stored in the first, second and third shift registers 42, 44, 46 to be latched in the first, second and third latch circuit 48, 50, 52, the signals of the bits b4, b3, b2 of the second bit group of the luminous data D latched in the first, second and third latch circuit 48, 50, 52 is supplied to the luminous pulse width control circuit 56 until the first LAT signal of the following luminous control period is supplied. Concurrently, the second period luminous control means 70 of the luminous control means 66 supplies the second GCP signal SG2 to the pulse width control signal generating circuit 54, and then, the second GCP signal SG2 is converted into a 3-bit parallel signal and the converted signal is supplied from the pulse width control signal generating circuit 54 to the luminous pulse width control circuit 56. The second GCP signal SG2 is a pulse defining timing of intensity level reduction at seven equal intervals of time in the second period K2 such that the intensity levels “28”, “24”, “20”, “16”, “12”, “8”, “4” and “0” correspond to reduction stage numbers “7”, “6”, “5”, “4”, “3”, “2”, “1” and “0”. In an example shown in FIG. 6, the intensity level defined by the luminous data D is “37”, the signals of the bits b4, b3, b2 of the second bit group are “0, 0, 1” and defining the reduction stage number “1”, and at t₁₈ the reduction stage number of the second GCP signal SG2 and the bits b4, b3, b2 of the second bit group of the luminous data D are compared in the luminous pulse width control circuit 56, then, a value defined by the bits b4, b3, b2 of the second bit group does not exceed a reduction stage number of the second GCP signal SG2, that is, since the reduction stage number of the second GCP signal SG2 is not larger than the value defined by the bits b4, b3, b2 of the second bit group, a comparison signal is output, and the driver 32 is placed in an on state until the second period K2 terminates, in synchronization with the comparison signal. This period in which the driver 32 is on corresponds to an intensity level “4” in 64 levels in total.

Since drive voltages that are luminous pulses corresponding to the on states of the driver 32 in the first and second periods K1, K2 are applied to the light-emitting element 22, the element 22 is driven in a duty ratio corresponding to the intensity level “37”, the sum of the intensity level “33” in the first period K1 and the intensity level “4” in the second period k2, as shown by the aforementioned luminous data D, and the element 22 is lighted in the intensity level “37” defined by the luminous data D.

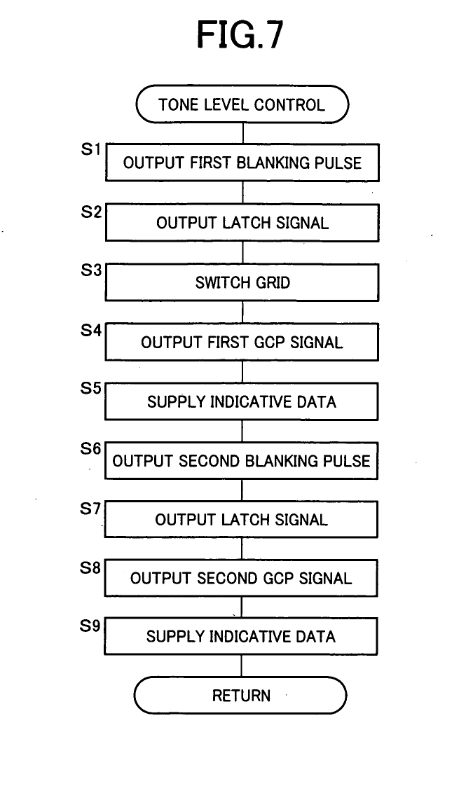

FIG. 7 is the flowchart for explaining a major part of control function of the display control unit 26. The control routine is initiated with step S1 (hereinafter, “step” being omitted) and S2 corresponding to the action of the timing control means 60, in S1 and S2 the first BK signal SB1 with a predetermined duration of time is output and the first LAT signal is output during raising of the first BK signal SB1 (from point t₁ to t₂ in FIG. 6). Then, in S3 corresponding to the action of the grid switching means 62, a control voltage is applied to a grid to light the light-emitting element 22 in the first period K1. And, in S4 corresponding to the action of the first period luminous control means 68 and the first period luminous control step, the first GCP signal SG1 is output, and the first scanning is implemented (from point t₃ to t₁₀ in FIG. 6) such that the luminous pulse and drive pulse of the driver 32 having the pulse width defined by the bits b5, b1, b0 of the first bit group stored in the first, second and third shift registers 42, 44, 46 can be obtained in the second period K2, the previous luminous control period prior to this first period K1.

In S5 corresponding to the action of the indicative data supply means 64 and the indicative data supply step, concurrently with the action in S4, in the first period K1, the bits b4, b3, b2 of the second bit group that are the indicative data D used in the following luminous control period K2 are supplied to the first, second and third input terminals 36, 38, 40, and to be stored in the first, second and third shift registers 42, 44, 46. The bits b4, b3, b2 of the second bit group are supplied in the first period K1, that is, the first indicative data supply period TD1 between points t₃ and t₁₀ in FIG. 6.

Thus, the first period K1 is terminated, and in S6 and S7 corresponding to the action of the timing control means 60, the second BK signal SB2 with a predetermined duration of time is output and the second LAT signal is output during raising of the second BK signal SB2 (from point t₁₀ to t₁₁ in FIG. 6). Then, in S8 corresponding to the action of the second period luminous control means 70 and the second period luminous control step, the second GCP signal SG2 is output, and the second scanning is implemented (from point t₁₂ to t₁₉ in FIG. 6) such that the luminous pulse and drive pulse of the driver 32 having the pulse width defined by the bits b4, b3, b2 of the second bit group in the luminous data D stored in the first, second and third shift registers 42, 44, 46 can be obtained in the second period K2. In S9 corresponding to the action of the indicative data supply means 64 and the indicative data supply step, concurrently with the action in S8, in the second period K2, the bits b5, b1, b0 of the first bit group that are the indicative data D used in the following first period K1 are supplied to the first, second and third input terminals 36, 38, 40, and to be stored in the first, second and third shift registers 42, 44, 46. The bits b5, b1, b0 of the first bit group are supplied in the second period K2, that is, the second indicative data supply period TD2 between points t₁₂ and t₁₉ in FIG. 6. For instance, when sixty-four (64) light-emitting elements 22 (defining 64 dots) are longitudinally aligned in the fluorescence display tube 12, since three bits are required to provide desired luminance for one light-emitting element 22, one hundred and ninety-two (192) bits in total of the indicative data per one column of the light-emitting elements 22 are required to be supplied in the first period K1 or second period K2.

As described above, according to the present embodiment, the indicative data D that are defining “64” intensity levels more than “8” intensity levels defined by three (3) bits corresponding to the number of the input terminals 36, 38, 40, are divided into the first bit group including the bits b5, b1, b0 and the second bit group including the bits b4, b3, b2, and the bits of the divided groups are alternately supplied to the first, second and third input terminals 36, 38, 40, in the first period K1 set within the luminous control period that is repeatedly assigned to a predetermined light-emitting element 22 selected from a plurality of light-emitting elements, the predetermined light-emitting element 22 is lighted in an intensity level corresponding to the indicative data of the first bit group including the bits b5, b1, b0 stored in the second period K2, and, furthermore, in the second period K2 following the first period K1, the predetermined light-emitting element 22 is lighted in an intensity level corresponding to the indicative data of the second bit group including the bits b4, b3, b2 stored in the first period K1. Accordingly, since the display drive control circuit 30 including the fewer input terminals 36, 38, 40 than the value of bits defining the intensity level of the aforementioned indicative data D and the following parallel signal processing circuits (the first, second and third shift registers 42, 44, 46 and the first, second and third latch circuits 48, 50, 52) is sufficient, even if the value of the intensity level increases, a small-sized display drive control circuits 30 can be provided at a reasonable cost.

According to the present embodiment, the first bit group including the bits b5, b1, b0 to control the intensity levels in the first period K1 includes the uppermost digit bit b5 and lowermost digit bit b0 in a plurality of bits constituting the indicative data D, and the second bit group including the bits b4, b3, b2 to control the intensity levels in the second period K2 includes a plurality of interposed digit bits, that is, b4, b3, b2 which are interposed among the bits b5, b1, b0 constituting the first bit group in a plurality of bits constituting the indicative data D. Accordingly, since the second period K2 has a longer duration of time in the present embodiment in which the second bit group is constituted of the bits b4, b3, b2, in comparison with another embodiment in which the second bit group is constituted of the bits b2, b1, b0, that is, the lower bits in a plurality of bits constituting the indicative data D, and the duration of time of the second period K2 approaches that of the first period K1, it is not necessary to reduce the luminance of the image display apparatus 10 or to use a high frequency clock for providing the indicative data D in order to define the second period K2, and, consequently, a small-sized display drive control circuits 30 can be provided at a reasonable cost.

According to the present embodiment, it is provided the image display apparatus wherein (a) the first period luminous control means 68 outputs a first GCP signal SG1 defining timing to steppingly reduce along with time elapsing in the first period K1; (b) the second period luminous control means 70 outputs a second GCP signal SG2 defining timing to steppingly reduce along with time elapsing in the second period K2; and (c) the display drive control circuit 30 includes a luminous pulse width control circuit 56 configured to compare a reduction stage number defined by the first GCP signal SG1 and the first bit group including b5, b1, b0 in the first period K1, and outputs a comparison signal when the reduction stage number defined by the first GCP signal SG1 is equal to or lower than a value defined by the first bit group including b5, b1, b0, and to compare a reduction stage number defined by the second GCP signal SG2 and the second bit group including b4, b3, b2 in the second period K2, and outputs a comparison signal when the reduction stage number defined by the second GCP signal SG2 is equal to or lower than a value defined by the second bit group including b4, b3, b2, and a driver (drive circuit) 32 configured to light the light-emitting element 22 in response to an output of the comparison signal from the luminous pulse width control circuit 56. Consequently, during the summed period of the first period K1 from the output of the comparison signal to the termination of the first period K1 and the second period K2 from the output of the comparison signal to the termination of the second period K2, the light-emitting element 22 is lighted, and it corresponds to the intensity level defining the indicative data D.

According to the present embodiment, it is provided the image display apparatus wherein (a) the plurality of light-emitting elements 22 disposed are fluorescent bodies that are disposed on a positive electrode of a fluorescence display tube 12 and are configured to light by collision of an electron generated in a cathode of the fluorescence display tube 12 and accelerated through any of a plurality of control grids Gn; and (b) the luminous control period assigned to the predetermined light-emitting element 22 is a period in which an accelerated voltage is applied to a control grid G covering the predetermined light-emitting element 22 selected from the control grids Gn; and the apparatus further includes (c) a grid switching means 62 for serially selecting a light-emitting element 22 capable of emitting light from the plurality of light-emitting elements 22 disposed, by serially and repeatedly applying a control voltage pulse to the plurality of control grids Gn. Consequently, the fluorescent body of the fluorescence display tube 12 is displayed in the intensity level of the indicative data D by fewer display drive control circuits 30 than the number of the bits defining the intensity level of the indicative data D. The display drive control circuits 30 includes the first, second and third input terminals 36, 38, 40 and the parallel signal processing circuits (the first, second and third shift registers 42, 44, 46 and the first, second and third latch circuits 48, 50, 52) connected to the input terminals.

According to the present embodiment, it is provided the image display apparatus wherein the grid switching means 62 serially and repeatedly applies one control voltage pulse having a time width corresponding to the first period K1 and the following second period K2 to the plurality of control grids Gn. Consequently, the light-emitting element 22 is displayed in the intensity level of the indicative data D by fewer display drive control circuits 30 than the number of the bits defining the intensity level of the indicative data D. The display drive control circuits 30 includes the first, second and third input terminals 36, 38, 40 and the parallel signal processing circuits (the first, second and third shift registers 42, 44, 46 and the first, second and third latch circuits 48, 50, 52) connected to the input terminals.

### Example 2

There will be described in detail another embodiment of the present invention. In the following descriptions, the same reference signs are assigned to the common components to the above and below embodiments and the description on them will be omitted.

The descriptions are common to this embodiment and the aforementioned embodiment in FIGS. 3 to 6 except the indicative data supply means 64 and the luminous control means 66.

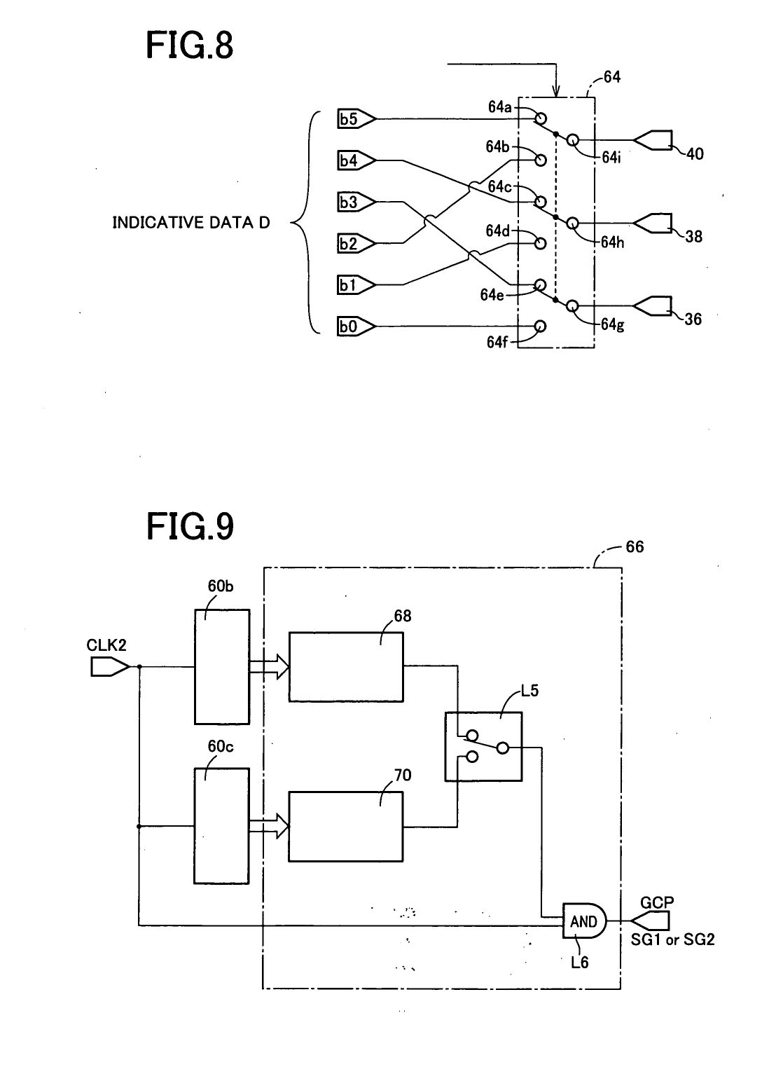

Referring to FIG. 8, the indicative data supply means 64 is provided with six input terminals 64a, 64b, 64c, 64d, 64e, 64f to which bits b5, b4, b3, b2, b1, b0 included in the 6-bit signal constituting the indicative data D are supplied in parallel, and output terminals 64g, 64h, 64i respectively connected to the first, second and third input terminals 36, 38, 40. The indicative data supply means 64 divides the 6-bit luminous data D into the first bit group including the upper part of the bit strings of b5, b4 and b3 and the second bit group including the lower part of the bit strings of b2, b1 and b0, by connecting the output terminal 64i to the input terminal 64a or 64b, the output terminal 64h to the input terminal 64c or 64d, and the output terminal 64g to the input terminal 64e or 64f, respectively, by switching, and the means 64 alternately outputs them in parallel.

Referring to FIG. 9, the luminous control means 66 in this embodiment includes the first period luminous control means 68 including a logic element to process an output signal from the binary counter 60b to count the CLK signal CLK2, and configured to output the first GCP signal SG1 for the first period K1 that is a pulse defining timing reducing at seven equal intervals corresponding to the intensity level reduction at seven equal intervals of time in the first period K1 as “56”, “48”, “40”, “32”, “24”, “16”, “8” and “0” in the intensity level, the second period luminous control means 70 including a logic element to process and a counter to count an output signal from the binary counter 60c to count the CLK signal CLK2, and configured to output the second GCP signal SG2 for the second period K2 that is a pulse defining timing reducing at seven equal intervals corresponding to the intensity level reduction at the last seven equal interval of time in the second period K2 as “7”, “6”, “5”, “4”, “3”, “2”, “1” and “0” in the intensity level, the switching device L5 to output a timing pulse from the first period luminous control means 68 in the first period K1 and a timing pulse from the second period luminous control means 70 in the second period K2, and the AND element L6 of which the gate is opened by the timing pulse from the first period luminous control means 68 in the first period K1 and by the timing pulses from the second period luminous control means 70 and the first period luminous control means 68 in the second period K2. Consequently, from the switching device L5 a gating signal to output the first GCP signal SG1 in the first period K1 is output, and a gating signal to output the second GCP signal SG2 in the second period K2 is output, through the AND element L6 in which the gate for the CLK signal CLK2 is opened, and respectively supplied to the pulse width control signal generating circuit 54

The control circuit 34 in this embodiment is provided with the first input terminal 36, second input terminal 38, third input terminal 40, first shift register 42, second shift register 44, third shift register 46, first latch circuit 48, second latch circuit 50, third latch circuit 52, GCP decoder 54, luminous pulse control circuit 56. Into the first, second and third input terminals 36, 38, 40, the upper digit bits b5 to b3 and the lower digit bits b2 to b0 of the 6-bit indicative data D defining luminance in 64 intensity levels are alternately input. The first, second and third shift registers 42, 44, 46, are configured to serially store each signal supplied into the first, second and third input terminals 36, 38, 40, respectively, in response to a CLK (clock) signal. The first, second and third latch circuits 48, 50, 52 are configured to latch each output signal from the first, second and third shift registers 42, 44, 46 for a predetermined period of time, in response to the LAT signal. The GCP decoder 54 is configured to convert the GCP signal into a 3-bit parallel signal. The luminous pulse control circuit 56 is configured to compare the 3-bit parallel signal converted from the GCP signal, with three bit signals from the first, second and third latch circuits 48, 50, 52, and to output a comparative output to the blanking circuit 58 when a value of the GCP signal is equal to or lower than a value defined by the three bit signals. The blanking circuit 58 is configured to interrupt a signal supplied from the luminous pulse width control circuit 56 to the driver 32 in response to a BK (blanking) signal, and to preferentially place the driver 32 in the off state.

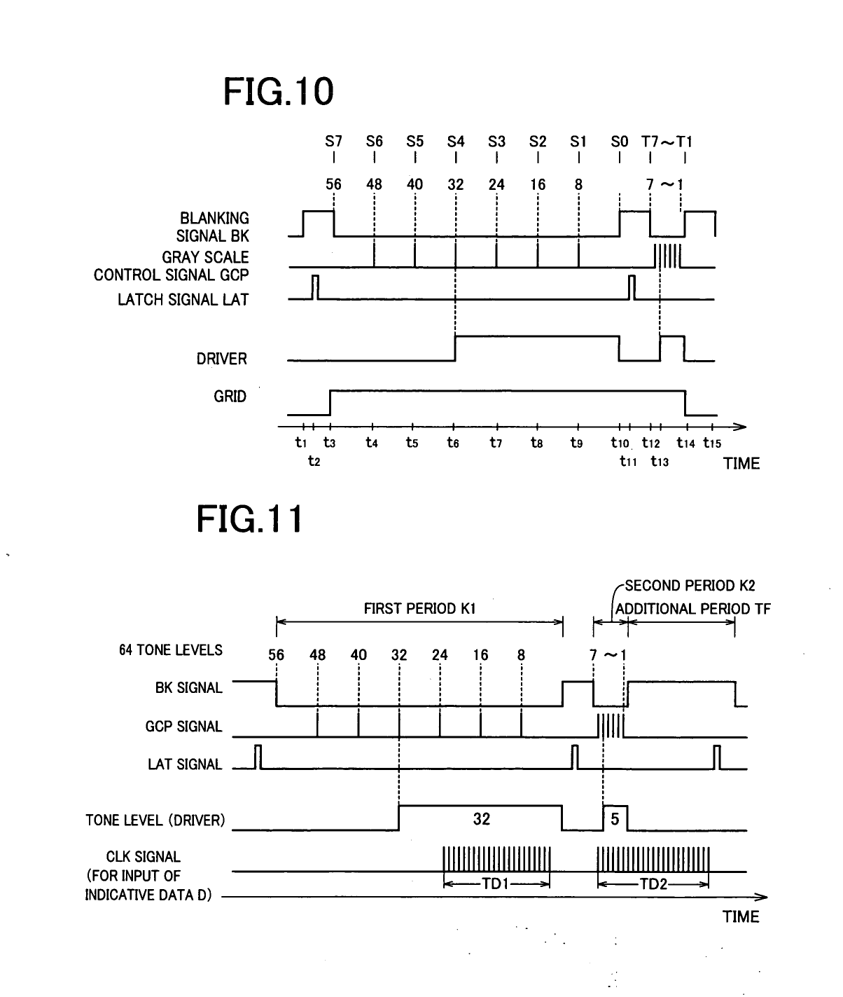

Referring to the time chart of FIG. 10 for explaining the functional blocks, this time chart shows timing and luminous control operation of the aforementioned signals in a luminous control period in which a control voltage is applied to one unit (one or adjacent two grids) of the grid to permit the one-columned light-emitting elements 22 to emit light, in one display cycle in which the grid voltage is serially applied to all the plurality of grids Gn. In one luminous control period, the first period K1 and second period K2 that are shorter than the first period K1 are disposed. In the first period K1 (from point t₃ to t₁₀) the first scanning to form the driver pulse width defined by the upper digit bits of the bits b5 to b3 of the indicative data D is implemented. In the second period K2 (from point t₁₂ to t₁₄) a second scanning to form a driver pulse width defined by the lower digit bits of the bits b2 to b0 of the indicative data D is implemented.

As shown in the time chart of FIG. 10, the timing control means 60 outputs the BK signal, LAT signal and CLK signal to the control circuit 34 in each of the luminous control period, and, concurrently, supplies timing signals to control such as initiation of an operation of the grid control means 62, indicative data supply means 64 and luminous control means 66. In the predetermined period of luminous control of the light-emitting element 22 implemented in the respective grid switching, the timing control means 60 generates the first BK signal having the predetermined pulse width at the point t₁ prior to the first period from point t₃ to t₁₀, and generates the second BK signal at the point t₁₀ prior to the second period from point t₁₂ to t₁₉.

In the aforementioned first period K1 in the prior luminous control period, the indicative data supply means 64 divides 6-bit luminous data D defining 64 intensity level luminance of the predetermined light-emitting element 22 in the present luminous control period, into the upper digit bits b5 to b3 and the lower digit bits b2 to b0, and at first supplies the signals of the upper digit bits b5 to b3 to the first, second and third input terminals 36, 38, 40, respectively. The supplied signals of the upper digit bits b5 to b3 are stored in the first, second and third shift registers 42, 44, 46, in synchronization with supplying the CLK signal. Then, the indicative data supply means 64 supplies the remaining signals of the lower digit bits b2 to b0 to the first, second and third input terminals 36, 38, 40, respectively. The supplied signals of the lower digit bits b2 to b0 are stored following the signals of the upper digit bits b5 to b3 in the first, second and third shift registers 42, 44, 46, in synchronization with supplying the CLK signal. In the present luminous control period, the indicative data supply means 64 divides the luminous data D for lighting in the following luminous control period as well, serially supplies the upper digit bits b5 to b3 and the lower digit bits b2 to b0 to the first, second and third input terminals 36, 38, 40, respectively, and has them serially stored in the first, second and third shift registers 42, 44, 46.

The timing control means 60 generates the first LAT signal (at point t₂) during generation of the aforementioned first BK signal, and generates the second LAT signal (at point t₁₁) during generation of the aforementioned second BK signal. By generation of the first LAT signal, the upper digit bits b5 to b3 of the luminous data D stored in the first, second and third shift registers 42, 44, 46 are latched in the first, second and third latch circuit 48, 50, 52, the upper digit bits b5 to b3 of the luminous data D latched in the first, second and third latch circuit 48, 50, 52 are supplied to the luminous pulse width control circuit 56 until supply of the second LAT signal.

When the timing control means 60 has the first BK signal fallen (at point t₃), the grid switching means 62 applies the control voltage to the grid G to light the predetermined light-emitting element 22 until the following luminous control period starts. Concurrently, the first period luminous control means 68 of the luminous control means 66 supplies the first GCP signal to the pulse width control signal generating circuit 54, and then, the first GCP signal is converted into the 3-bit parallel signal and the converted signal is supplied from the pulse width control signal generating circuit 54 to the luminous pulse width control circuit 56. The first GCP signal is a function of time which presents such that a value is steppingly reduced by a predetermined value as “56”, “48”, “40”, “32”, “24”, “16”, “8” and “0” at seven equal intervals of time in the first period K1. In an example shown in FIG. 10, the intensity level defined by the luminous data D is “37”, the signals of the upper digit bits b5 to b3 are “1, 0, 0” and the signals of the lower digit bits b2 to b0 are “1, 0, 1”, and at point t₆ the first GCP signal and the upper digit bits b5 to b3 of the luminous data D are compared in the luminous pulse width control circuit 56, then, since the value defined by the upper digit bits b5 to b3 exceeds that by the first GCP signal, a comparison signal is output, and the driver 32 is placed in the on state until the second BK signal is raised, in synchronization with the comparison signal.

When the timing control means 60 raises the second BK signal (at point t₁₀) and generates the second LAT signal (at point t₁₁) during raising of the second BK signal, the generation of the second LAT signal causes the signals of the lower digit bits b2 to b0 of the luminous data D stored in the first, second and third shift registers 42, 44, 46 to be latched in the first, second and third latch circuit 48, 50, 52, the signals of the lower digit bits b2 to b0 of the luminous data D latched in the first, second and third latch circuit 48, 50, 52 is supplied to the luminous pulse width control circuit 56 until the first LAT signal of the following luminous control period is supplied. Concurrently, the second period luminous control means 70 of the luminous control means 66 supplies the second GCP signal to the pulse width control signal generating circuit 54, and then, the second GCP signal is converted into the 3-bit parallel signal and the converted signal is supplied from the pulse width control signal generating circuit 54 to the luminous pulse width control circuit 56. The second GCP signal is a function of time which presents such that a value is steppingly reduced in a period of one seventh of the first period, that is, the duration of the first GCP signal by a predetermined value as “7”, “6”, “5”, “4”, “3”, “2”, “1” and “0” at seven equal intervals of time in the second period. In an example shown in FIG. 10, the intensity level defined by the luminous data D is “37”, the signals of the lower digit bits b2 to b0 are “1, 0, 1”, and at t₁₃ the second GCP signal and the lower digit bits b2 to b0 of the luminous data D are compared in the luminous pulse width control circuit 56, then, since the value defined by the lower digit bits b2 to b0 exceeds that by the second GCP signal, a comparison signal is output, and the driver 32 is placed in the on state until the second period terminates, in synchronization with the comparison signal.

Since drive voltages that are luminous pulses corresponding to the on states of the driver 32 in the first and second periods K1, K2 are applied to the light-emitting element 22, the element 22 is driven in a duty ratio corresponding to the intensity level “37” defined by the aforementioned luminous data D, and the element 22 is lighted in the intensity level “37” defined by the luminous data D.

Also in this embodiment, the control routine goes along with the flowchart as well as that in FIG. 7 for explaining a major part of control function of the display control unit 26.

According to the present embodiment, the indicative data D that are defining “64” intensity levels more than “8” intensity levels defined by three (3) bits corresponding to the number of the input terminals 36, 38, 40, are divided into the upper digit bits b5 to b3 and the lower digit bits b2 to b0, and they are alternately supplied to the first, second and third input terminals 36, 38, 40, in the first period K1 set within the luminous control period that is repeatedly assigned to a predetermined light-emitting element 22 selected from the plurality of light-emitting elements, the predetermined light-emitting element 22 is lighted in a relatively roughly-set intensity level corresponding to the upper digit bits b5 to b3 by supplying the indicative data of the upper digit bits b5 to b3 to the first, second and third input terminals 36, 38, 40, and, furthermore, in the second period determined as shorter than the first period, the predetermined light-emitting element 22 is lighted in a relatively finely-set intensity level corresponding to the lower digit bits b2 to b0 by supplying the indicative data of the lower digit bits b2 to b0 to the first, second and third input terminals 36, 38, 40. Accordingly, since the display drive control circuit 30 including the fewer input terminals 36, 38, 40 than the value of bits defining the intensity level of the aforementioned indicative data D and the following parallel signal processing circuits (the first, second and third shift registers 42, 44, 46 and the first, second and third latch circuits 48, 50, 52) is sufficient, even if the value of the intensity level increases, a small-sized display drive control circuits 30 can be provided at a reasonable cost.

According to the present embodiment, it is provided the image display apparatus wherein (a) the first period luminous control means 68 supplies a first GCP signal defining a value steppingly reduced along with time elapsing in the first period, to the first, second and third input terminals 36, 38, 40; (b) the second period luminous control means 70 supplies a second GCP signal defining a value steppingly reduced along with time elapsing in the second period, to the first, second and third input terminals 36, 38, 40; and (c) the display drive control circuit 30 includes a luminous pulse width control circuit 56 configured to compare the first GCP signal and the upper digit bits b5 to b3, and outputs a comparison signal during that the value defined by the upper digit bits b5 to b3 exceeds that of the first GCP signal, and to compare the second GCP signal and the lower digit bits b2 to b0, and outputs a comparison signal during that the value defined by the lower digit bits b2 to b0 exceeds that of the second GCP signal, and a driver (drive circuit) 32 configured to output a luminous pulse to light the light-emitting element 22 in response to an output of the comparison signal from the luminous pulse width control circuit 56. Consequently, during the summed period of the first period from the output of the comparison signal to the termination of the first period and the second period from the output of the comparison signal to the termination of the second period, the light-emitting element 22 is lighted, and it corresponds to the intensity level defining the indicative data D.

According to the present embodiment, it is provided the image display apparatus wherein (a) the plurality of light-emitting elements 22 disposed are fluorescent bodies that are disposed on a positive electrode of a fluorescence display tube 12 and are configured to light by collision of an electron generated in a cathode of the fluorescence display tube 12 and accelerated through any of a plurality of control grids Gn; and (b) the luminous control period assigned to the predetermined light-emitting element 22 is a period in which an accelerated voltage is applied to a control grid G covering the predetermined light-emitting element 22 selected from the control grids Gn; and the apparatus further includes (c) a grid switching means 62 for serially selecting a light-emitting element capable of emitting light from the plurality of light-emitting elements 22 disposed, by serially and repeatedly applying a control voltage pulse to the plurality of control grids Gn. Consequently, the fluorescent body of the fluorescence display tube 12 is displayed in the intensity level of the indicative data D by fewer display drive control circuits 30 than the number of the bits defining the intensity level of the indicative data D. The display drive control circuits 30 includes the first, second and third input terminals 36, 38, 40 and the parallel signal processing circuits (the first, second and third shift registers 42, 44, 46 and the first, second and third latch circuits 48, 50, 52) connected to the input terminals.

According to the present embodiment, it is provided the image display apparatus wherein the grid switching means 62 serially and repeatedly applies one control voltage pulse having a time width corresponding to the first period and the following second period to the plurality of control grids Gn. Consequently, the light-emitting element 22 is displayed in the intensity level of the indicative data D by fewer display drive control circuits 30 than the number of the bits defining the intensity level of the indicative data D. The display drive control circuits 30 includes the first, second and third input terminals 36, 38, 40 and the parallel signal processing circuits (the first, second and third shift registers 42, 44, 46 and the first, second and third latch circuits 48, 50, 52) connected to the input terminals.

In the display drive control circuit 30 of the present embodiment, the indicative data D is divided into two groups, that is, the upper digit bits b5, b4, b3 and the lower digit bits b2, b1, b0 and they are to be alternately input to the first, second and third input terminals 36, 38, 40, since the intensity level defined by the lower digit bits b2, b1, b0 has a narrow width for representing the intensity level, the second period K2 between the second BK signal SB2 and the first BK signal SB1 is short and one eighth (⅛) of the indicative cycle in the 64 intensity levels with regard to the intensity level indicative control, however, when the lower digit bits b2, b1, b0 are supplied through the first, second and third input terminals 36, 38, 40 to the first, second and third shift registers 42, 44, 46 to be serially stored, a relatively long duration as well as the second indicative data supply period TD2 in FIG. 6 is required. To solve it, for instance, replacement of the clock with a high-frequency clock is useful. In the case of no replacement, since the second indicative data supply period TD2 exceeds the duration of time between the second BK signal SB2 and the first BK signal SB1, as shown in FIG. 11, the proper second indicative data supply period TD2 can be obtained such that an additional period TF to supply the upper digit bit group of b5, b4, b3 of the indicative data D follows the second period K2. Since this additional period TF is set for supplying the upper digit bit group of b5, b4, b3 to the first, second and third shift registers 42, 44, 46 and does not affect light-emitting of the fluorescence display tube 12, it causes reduction in the luminous duty of the light-emitting element 22 and certain reduction in luminance of the fluorescence display tube 12, however, even if the value of the intensity level increases, it is effectively provided a small-sized display drive control circuits 30 at a reasonable cost.

### Example 3

There will be described in detail another embodiment of the present invention. In the following descriptions, the same reference signs are assigned to the common components to the above and below embodiments and the description on them will be omitted.

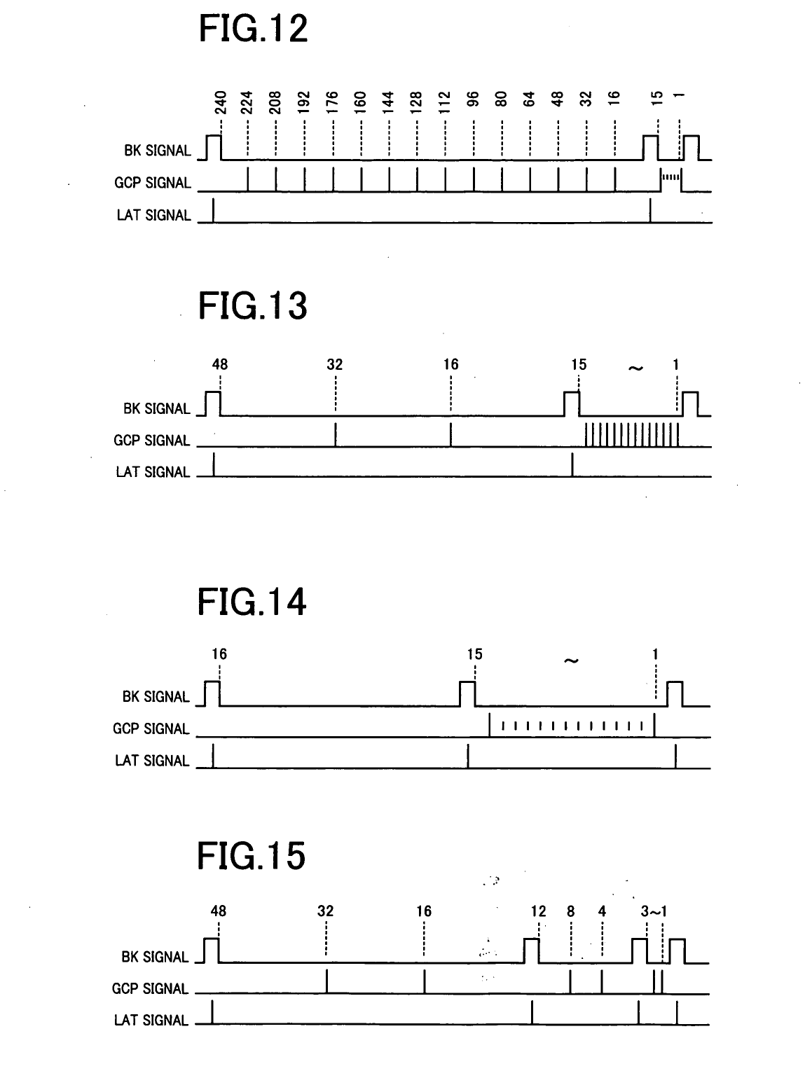

FIG. 12 illustrates the time chart for explaining the functional action of another embodiment of the present invention, and corresponds to FIGS. 6 and 10. In this embodiment, using 8-bit indicative data D defining 256 intensity levels, the indicative data D is divided into upper digit bits b7 to b4 and lower digit bits b3 to b0 are alternately input to four input terminals provided on the display drive control circuit 30. The second period is determined such that its duration is one fifteenth ( 1/15) of the first period. The first GCP signal reducing from “240” to “0” with fifteen stages in total is used in the first period, and the second GCP signal reducing from “15” to “0” with fifteen stages in total is used in the second period. According to this embodiment, the light-emitting element 22 is displayed in 256 intensity levels defining the indicative data D using the display drive control circuit 30 including four input terminals and four systems of the signal processing circuits (four shift registers and four latch circuits) connected to the input terminals.

### Example 4

FIG. 13 illustrates the time chart for explaining the functional action of another embodiment of the present invention, and corresponds to FIGS. 6 and 10. In this embodiment, using 6-bit indicative data D defining 64 intensity levels, the indicative data D is divided into two upper digit bits b5 to b4 and four lower digit bits b3 to b0 are alternately input to four input terminals provided on the display drive control circuit 30. The second period is determined such that its duration is one third (⅓) of the first period. The first GCP signal reducing from “48” to “0” with three stages in total is used in the first period, and the second GCP signal reducing from “15” to “0” with fifteen stages in total is used in the second period. According to this embodiment, the light-emitting element 22 is displayed in 64 intensity levels defining the indicative data D using the display drive control circuit 30 including four input terminals and four systems of the signal processing circuits (four shift registers and four latch circuits) connected to the input terminals.

### Example 5

FIG. 14 illustrates the time chart for explaining the functional action of another embodiment of the present invention, and corresponds to FIGS. 6 and 10. In this embodiment, using 5-bit indicative data D defining 32 intensity levels, the indicative data D is divided into one upper digit bit b4 and four lower digit bits b3 to b0 are alternately input to four input terminals provided on the display drive control circuit 30. The second period is determined such that its duration is a little shorter than the first period. The first GCP signal reducing from “16” to “0” with one stage in total is used in the first period, and the second GCP signal reducing from “15” to “0” with fifteen stages in total is used in the second period. According to this embodiment, the light-emitting element 22 is displayed in 32 intensity levels defining the indicative data D using the display drive control circuit 30 including four input terminals and four systems of the signal processing circuits (four shift registers and four latch circuits) connected to the input terminals.

### Example 6

FIG. 15 illustrates the time chart for explaining the functional action of another embodiment of the present invention, and corresponds to FIGS. 6 and 10. In this embodiment, using 6-bit indicative data D defining 64 intensity levels, the indicative data D is divided into two upper digit bits b5 to b4, two mid digit bits b3 to b2 and two lower digit bits b1 to b0 are alternately input to four input terminals provided on the display drive control circuit 30. The second period is determined such that its duration is one third (⅓) of the first period, the third period is determined such that its duration is one third (⅓) of the second period, and one luminous control period corresponding to one light-emitting element 22 is constituted of the first, second and third periods. The first GCP signal reducing from “48” to “0” with three stages in total is used in the first period, and the second GCP signal reducing from “12” to “0” with three stages in total is used in the second period, and the third GCP signal reducing from “3” to “0” with three stages in total is used in the third period. According to this embodiment, the light-emitting element 22 is displayed in 64 intensity levels defining the indicative data D using the display drive control circuit 30 including two input terminals and two systems of the signal processing circuits (two shift registers and two latch circuits) connected to the input terminals.

While the preferred embodiment of this invention has been described above in detail by reference to the drawings, it is to be understood that the invention may be otherwise embodied.

In the aforementioned Example 1, for instance, in the luminous control period in which the control voltage is applied to one unit of grids to light the light-emitting element 22 in the one grid scanning, there are set the first period K1 for the first scanning to generate the luminous pulse corresponding to the intensity level defined by the first bit group including b5, b1, b0 of the defined data D, and the second period K2 for the second scanning to generate the luminous pulse corresponding to the intensity level defined by the second bit group including b4, b3, b2 of the defined data D. Or the second period K2 for the lower scanning may be conducted for one picture after the first period K2 for the upper scanning is conducted for one picture.

In the aforementioned Example 1, the second period K2 is set following the first period K1 within one luminous control period as shown in FIG. 6. The first period K1 may be set following the second period K2.

In the aforementioned Example 1, the indicative data D for displaying in 64 intensity levels is divided into the 3-bit first bit group including b5, b1, b0 and the 3-bit second bit group including b4, b3, b2. For instance, the indicative data D for displaying in 128 intensity levels may be divided into the 3-bit first bit group including b6, b1, b0 and the 4-bit second bit group including b5, b4, b3, b2. It is not necessarily required that the first bit group and second bit group have equal number of bits functioning as the indicative data D.

In the aforementioned Example 1, the indicative data D is divided into the 3-bit first bit group of b5, b1, b0 including the uppermost digit bit b5 and the lowermost digit bit b0 and the second bit group of b4, b3, b2 including intermediate bits between the uppermost digit bit and the lowermost digit bit, selected from the bit strings b5, b4, b3, b2, b1, b0 in order constituting the indicative data D. Or the first bit group may be constituted of b5, b2, b0 and the second bit group may be constituted of b4, b3, b1, or the first bit group may be constituted of b5, b3, b0 and the second bit group may be constituted of b4, b2, b1. That is, it is sufficient that the first bit group ensures the first indicative data supply period TD1 in the first period K1 and the second bit group ensures the second indicative data supply period TD2 in the second period K2. Consequently, it is sufficient that the indicative data D is divided into the first bit group including a plurality of bits which constitute each of the bit strings and are positioned in non-successive order in the bit string, selected from the bit strings constituting the indicative data D, and the second bit group including a plurality of bits which are not included in the first bit group.

In the aforementioned Example 1, the fluorescence display tube 12 functioning as the image display device is provided in the image display apparatus 10. Or an LED image display device in which a plurality of LED chips disposed on a surface of the substrate and operating in the simple matrix drive are used for displaying images, is available. An LCD image display device operating in the simple matrix drive is available as the image display device.

In the aforementioned Example 1, the first period luminous control means 68 outputs the first GCP signal SG1 steppingly reducing along with time elapsing in the first period K1; the second period luminous control means 70 outputs a second GCP signal SG2 steppingly reducing along with time elapsing in the second period K2; and the luminous pulse width control circuit 56 compares the first GCP signal SG1 steppingly reducing along with time elapsing and the first bit group including b5, b1, b0 in the first period K1, and outputs the comparison signal when the first GCP signal SG1 is equal to or lower than a value defined by the first bit group including b5, b1, b0, and compares the second GCP signal SG2 steppingly reducing along with time elapsing and the second bit group including b4, b3, b2 in the second period K2, and outputs the comparison signal when the second GCP signal SG2 is equal to or lower than a value defined by the second bit group including b4, b3, b2. Or it is also available to proceed such that the first period luminous control means 68 outputs the first GCP signal SG1 steppingly increasing along with time elapsing in the first period K1; the second period luminous control means 70 outputs a second GCP signal SG2 steppingly increasing along with time elapsing in the second period K2; and the luminous pulse width control circuit 56 compares the first GCP signal SG1 steppingly increasing along with time elapsing and the first bit group including b5, b1, b0 in the first period K1, and outputs the comparison signal when the first GCP signal SG1 exceeds a value defined by the first bit group including b5, b1, b0, and compares the second GCP signal SG2 steppingly increasing along with time elapsing and the second bit group including b4, b3, b2 in the second period K2, and outputs the comparison signal when the second GCP signal SG2 exceeds a value defined by the second bit group including b4, b3, b2. In this case, during the summed period of the first period K1 from the initiation of the first period K1 to the output of the comparison signal and the second period K2 from the initiation of the second period K2 to the output of the comparison signal, the light-emitting element 22 is lighted, and it corresponds to the intensity level defining the indicative data. The driver (drive circuit) 32 puts out the light-emitting element 22 in response to the comparison signal. Such a variation is applicable not only to the Example 1 but to the Example 2.

In such as the aforementioned Examples 1 and 2, in the luminous control period in which the control voltage is applied to one unit of grids to light the light-emitting element 22 in the one grid scanning, there are set the first period for the upper digit scanning to generate the luminous pulse corresponding to the intensity level defined by the upper digit bits of the defined data D, and the second period for the lower digit scanning to generate the luminous pulse corresponding to the intensity level defined by the lower digit bits of the defined data D. Or the second period for the lower scanning may be conducted for one picture after the first period for the upper scanning is conducted for one picture.

In the aforementioned Examples, the fluorescence display tube 12 functioning as the image display device is provided in the image display apparatus 10. Or an LED image display device in which a plurality of LED chips disposed on a surface of the substrate and operating in the simple matrix drive are used for displaying images, is available. An LCD image display device operating in the simple matrix drive is available as the image display device.

It is to be understood that the present invention may be embodied with other changes, improvements, and modifications that may occur to a person skilled in the art without departing from the scope and spirit of the invention defined in the appended claims.

1. An image display method for displaying an image having an intensity level defined by indicative data, including a plurality of light-emitting bodies disposed on a surface to constitute a plurality of respective pixels, a parallel signal processing circuit corresponding to a plurality of input terminals and output terminals to which the indicative data supplied to light the plurality of light-emitting bodies are input, comprising:
a display data supply step for dividing a plurality of bits constituting the indicative data that define the number of the intensity level more than the number of the intensity level defined by the number of a bit corresponding to the number of the input terminal, into a first bit group and a second bit group, and for alternately supplying them to the input terminals;
a first period luminous control step for lighting predetermined light-emitting bodies selected from the plurality of light-emitting bodies in an intensity level corresponding to the first bit group of the indicative data, in a first period set in a luminous control period that is repeatedly assigned to the predetermined light-emitting bodies; and
a second period luminous control step for lighting the predetermined light-emitting bodies in an intensity level corresponding to the second bit group of the indicative data, in a second period set following the first period in the luminous control period.

2. The image display method of claim 1, wherein the display data supply step divides the plurality of bit strings constituting the indicative data into the first bit group including a plurality of bits which constitute each of the bit strings and are positioned in non-successive order in the bit string and the second bit group including a plurality of bits except the bits included in the first bit group, and alternately supplies them to the input terminals.

3. The image display method of claim 2, wherein the first bit group includes an uppermost bit and a lowermost bit of each of the indicative data, and the second bit group includes a plurality of intermediate bits interposed by the bits constituting the first bit group.

4. The image display method of claim 1, wherein the display data supply step divides the plurality of bit strings constituting the indicative data into the first bit group including upper part of the bit strings and the second bit group including lower part of the bit strings, and alternately supplies them to the input terminals.

5. An image display apparatus for displaying an image having an intensity level defined by indicative data, including a plurality of light-emitting bodies disposed on a surface to constitute a plurality of respective pixels, a parallel signal processing circuit corresponding to a plurality of input terminals and output terminals to which the indicative data supplied to light the plurality of light-emitting bodies are input, comprising:
a display data supply means for dividing a plurality of bits constituting the indicative data that define the number of the intensity level more than the number of the intensity level defined by the number of a bit corresponding to the number of the input terminal, into a first bit group and a second bit group, and for alternately supplying them to the input terminals;
a first period luminous control means for lighting predetermined light-emitting bodies selected from the plurality of light-emitting bodies in an intensity level corresponding to the indicative data of the first bit group, in a first period set in a luminous control period that is repeatedly assigned to the predetermined light-emitting bodies; and
a second period luminous control means for lighting the predetermined light-emitting bodies in an intensity level corresponding to the indicative data of the second bit group, in a second period set following the first period in the luminous control period.

6. The image display apparatus of claim 5, wherein the display data supply means divides the plurality of bit strings constituting the indicative data into the first bit group including a plurality of bits which constitute each of the bit strings and are positioned in non-successive order in the bit string and the second bit group including a plurality of bits except the bits included in the first bit group, and alternately supplies them to the input terminals.

7. The image display apparatus of claim 6, wherein the first bit group includes an uppermost bit and a lowermost bit of the indicative data, and the second bit group includes a plurality of intermediate bits interposed by the bits constituting the first bit group.

8. The image display apparatus of claim 5, wherein the display data supply means divides the plurality of bit strings constituting the indicative data into the first bit group including upper part of the bit strings and the second bit group including lower part of the bit strings, and alternately supplies them to the input terminals.

9. The image display apparatus of claim 5, wherein:
the first period luminous control means outputs a first GCP signal defining timing to steppingly reduce along with time elapsing in the first period;
the second period luminous control means outputs a second GCP signal defining timing to steppingly reduce along with time elapsing in the second period; and
the display drive control circuit includes a luminous pulse width control circuit configured to compare the first GCP signal and the first bit group in the first period, and to output a comparison signal when a value defined by the first GCP signal is equal to or lower than a value defined by the first bit group, and to compare the second GCP signal and the second bit group in the second period, and to output a comparison signal when a value defined by the second GCP signal is equal to or lower than a value defined by the second bit group, and a drive circuit configured to light the light-emitting element in response to an output of the comparison signal from the luminous pulse width control circuit.

10. The image display apparatus of claim 5, wherein:
the first period luminous control means outputs a first GCP signal defining timing to steppingly increase along with time elapsing in the first period;
the second period luminous control means outputs a second GCP signal defining timing to steppingly increase along with time elapsing in the second period; and
the display drive control circuit includes a luminous pulse width control circuit configured to compare the first GCP signal and the first bit group in the first period, and to output a comparison signal when a value defined by the first GCP signal exceeds a value defined by the first bit group, and to compare the second GCP signal and the second bit group in the second period, and to output a comparison signal when a value defined by the second GCP signal exceeds a value defined by the second bit group, and a drive circuit configured to put out the light-emitting element in response to an output of the comparison signal from the luminous pulse width control circuit.

11. The image display apparatus of claim 5, wherein:
the plurality of light-emitting bodies disposed are fluorescent bodies that are disposed on a positive electrode of a fluorescence display tube and are configured to light by collision of an electron generated in a cathode of the fluorescence display tube and accelerated through any of a plurality of control grids; and
the luminous control period assigned to the predetermined light-emitting bodies is a period in which an accelerated voltage is applied to a control grid covering the predetermined light-emitting bodies selected from the control grids;
the apparatus further comprising:
a grid switching means for serially selecting light-emitting bodies capable of emitting light from the plurality of light-emitting bodies disposed, by serially and repeatedly applying a control voltage pulse to the plurality of control grids.

12. The image display apparatus of claim 11, wherein the grid switching means serially and repeatedly applies one control voltage pulse having a time width corresponding to the first period and the following second period to the plurality of control grids.

13. The image display apparatus of claim 11, wherein the grid switching means serially applies a first control voltage pulse having a time width corresponding to the first period to the plurality of control grids, and then serially applies a second control voltage pulse having a time width corresponding to the second period to the plurality of control grids, and repeatedly applies them.
